(19) United States
(12) Patent Application Publication
(10) Pub. No.: US 2007/0150174 A1
(43) Pub. Date: Jun. 28, 2007

(54) Predictive navigation

(76) Inventors: Shafer B. Seymour, Bartlett, IL (US); Ramy P. Ayoub, Arlington Heights, IL (US); Michael H. Kraus, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 11/298,427

(22) Filed: Dec. 8, 2005

(51) Int. Cl. G01C 21/00

(52) U.S. Cl. 701/200

(57) ABSTRACT

The present disclosure provides an on-board navigation system for a commuter vehicle that automatically saves in a database addresses corresponding to destinations to which the vehicle has traveled, along with one or more parameters relating to the addresses. The navigation system uses these parameters to predict a destination by comparing the present state of the vehicle to the saved parameters. The navigation system can present the user with a prioritized list of addresses based on the predicted and prompt the user to select a destination from list. Thus a user can conveniently inform the navigation system of an intended destination. The navigation system can automatically determine a route to the destination based on present traffic conditions, and may have the ancillary benefit of informing the user of traffic conditions, or directing the user around such traffic conditions, even if the user was not otherwise interested in receiving a route.

### CROSS REFERENCE TO RELATED APPLICATIONS

This application is concurrently filed with U.S. patent application Ser. No.______, entitled “Predictive Navigation,” which is incorporated herein by reference in its entirety.

### FIELD OF THE INVENTION

This invention relates to navigation systems for commuter vehicles. More specifically, the invention relates to a vehicle navigation system that predicts a vehicle's destination and determines the best route to the destination.

### BACKGROUND

Navigation systems are becoming increasingly common in commuter vehicles. Such systems typically features a display for displaying graphical or text data, for example a map including a present position or driving directions; a processor; a global positioning system (GPS) receiver; a memory/storage; and a user input interface. Many systems also include additional receiver(s) for receiving real time information such as traffic reports, weather reports, etc.

The navigation system can determine an optimal route to a destination. The system typically contains map data for a given zone of interest, for example, the user's city, state, and/or region. A user wanting directions to a particular destination inputs the address of the destination and the system determines one or more routes to the destination based on the map data and user's present position supplied by GPS receiver. The processor may also consider real time traffic conditions provided by a receiver in formulating the route(s). For example, the shortest route to a destination may not be the fastest route at a given time because of traffic congestion or an accident along the shortest route. A service provider outside of the vehicle can provide information concerning these conditions so that the navigation system can determine the most efficient, although not necessarily the shortest, route at a given time. The route can be continually updated to adapt to updated information.

Commuters frequently travel routes that are familiar and in such situations would not typically request the navigation system to determine a route. For example, during rush hour, numerous commuters travel the same route they travel every day. Such commuters are unlikely to solicit the navigation system to determine their route and would therefore forfeit the benefit of having the navigation system consider traffic conditions along the familiar route. However, this sometimes leads to long travel times, because had a given commuter consulted the navigation system, the commuter might have been made aware of congestion or other adverse conditions that could have been avoided if he had the benefit of such information that the navigation system could have provided.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a navigation system configured to prompt a user to select a destination from a list of destinations in a database.

FIG. 2 illustrates a database of parameters associated with trips taken by a vehicle.

FIG. 3 is a flow diagram illustrating the storage of solicited and unsolicited route data and parameters.

FIG. 4 is a flow diagram depicting the predictive navigation algorithm.

FIG. 5 is an example of a predictive navigation route.

### DETAILED DESCRIPTION

The present disclosure provides a navigation system that is configured to store destinations in a database. When a user begins traveling in a vehicle, the navigation system can predict the destination from among stored destinations based on parameters such as the vehicle's present position, the time of day, historical travel patterns, etc. For example, if a trip begins in the early evening on a weekday and the vehicle's current position is at an address that the navigation system recognizes as a starting point (e.g., user's office) of a trip that normally leads him to a destination point (e.g., users home), the navigation system might guess that the destination is the user's home. The navigation system can prompt the user and confirm the destination. In addition, the predictive navigation algorithm may select multiple possible destinations and trips from the current set of time, location, heading parameters. For example, drivers may go to a grocery store on their way home from work on a regular basis. Therefore, the predictive navigation solution in the navigation system may predict home and the grocery stores as the possible destinations based on the predicted routes. The navigation system can prompt the user to select a destination from a list of the stored destinations and the list of destinations are prioritized according to the navigation system's prediction of the most likely of the destinations. Once the user confirms or selects a destination, the navigation system calculates a route considering current roadway conditions, of which user might be unaware. Thus, even though user is familiar with the route to be traveled and otherwise would not of his own accord consult the navigation system capabilities available to him, the smart navigation system operates regardless, displaying the predicted routes, showing travel times for the predicted routes, and when selected by the user, suggesting an alternate route to that assumed by the user based on information about roadway conditions.

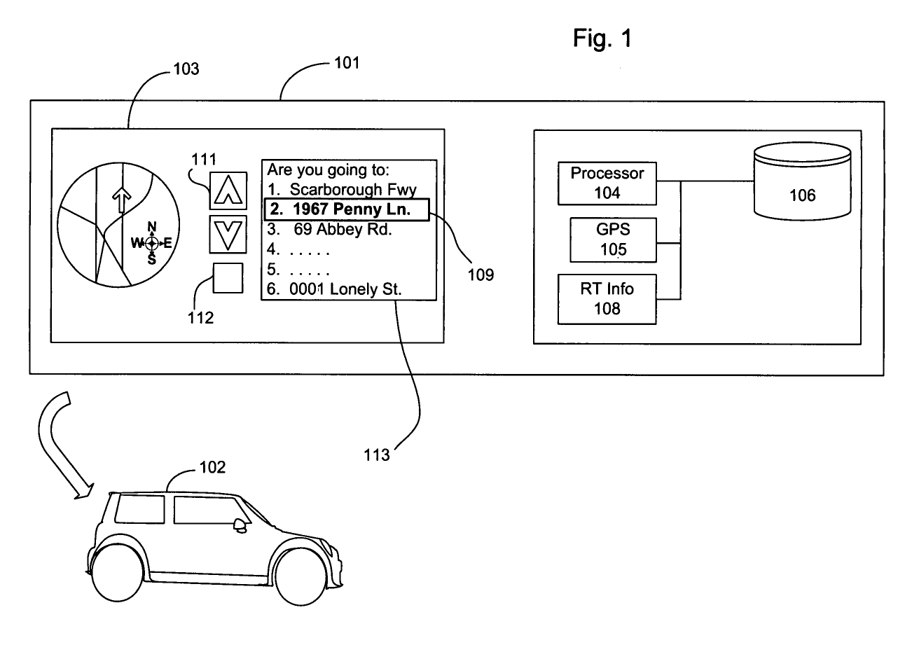

FIG. 1 illustrates a navigation system 101 installed in a vehicle 102. The navigation system 101 features a display 103 for displaying graphical data, for example a map depicting present position and/or route data. The system 101 includes a user input interface (not shown) for changing the scale of the display, inputting the address of a destination, etc., and such user input interface may include interactive voice response technologies. Navigation system 101 also includes a processor 104; a GPS receiver 105; a traffic information receiver 108; and a memory/storage 106. The processor 104, the traffic information receiver 108 and the memory/storage 106 may also reside on a remote back-end server in off-board navigation solutions.

The features of navigation system 101 described thus far function similarly to navigation systems that are known in the art. For example, a user of the navigation system 101 can use the system to determine the most efficient route to a destination. The memory/storage 106 typically contains map data for a given zone of interest, for example, the user's city, state, and/or region. The memory/storage 106 also contains the destination information for solicited routes from the navigation system 101. The processor 104 determines one or more routes to the destination based on the map data and user's present position supplied by the GPS receiver 105. The processor 104 may also consider real time traffic conditions provided by the traffic information receiver 108.

The navigation system 101 of the present invention, however, also maintains a database of all solicited destinations (i.e., addresses) to which the vehicle 102 has traveled, as well as all unsolicited destinations and related parameters to which the vehicle 102 has traveled. Thus, the system 101 displays a list of saved destinations 113 and prompts the user to select a destination from the displayed destinations, regardless of whether the user explicitly solicits the use of the navigation system 101, or not, such as the user would not be inclined to do when anticipating travel along a well-known route. The user can scroll among stored addresses 113 using arrow buttons 111 and select a destination using button 112. In FIG. 1, destination 109 is selected, as indicated by highlighting, shading, boxing, etc. This description of the interface is not meant to be limiting; any format that displays saved addresses and permits a user to select a destination from among the addresses can be used. For example, the display 103 can be configured to toggle between a textual and a graphical mode.

The database of destinations 113 can include addresses that the user has previously entered into the navigation system 101, for example, because the user has requested directions to the address. Also, the navigation system 101 can be configured to store the address corresponding to the final position of the vehicle 102 before the navigation system 101 is turned off. The system 101 knows the vehicle 102's final position via the GPS receiver 105.

Because the navigation system 101 presents the user with the convenient option to select a destination from a displayed list of addresses, the user is more inclined to select a destination, even thought the user might not actually need route data to the destination. In other words, the user might not be inclined to take the time to manually input a destination into the navigation system 101 if the user already knows how to get there, but if the user simply has to select from a list, the user might be more inclined to do so. In another embodiment, to further assist the user in selecting a destination from the list, the navigation system 101 calculates the expected travel times for each predicted destination shown on the list, and displays the travel times to the user. All travel times above average is highlighted to the user. Thus, the user benefits from the navigation system's ability to calculate a route based on information about traffic conditions, including accidents and/or congestion, of which the user might be unaware.

According to one embodiment, the navigation system 101 predicts one or more destinations based on a matrix of parameters and prioritizes the list of destinations based on the prediction. Therefore, a user does not have to scroll through the entire list of potential addresses to find his desired destination, as those addresses or destinations that are unlikely given current conditions are discarded.

According to one embodiment, the navigation system 101 predicts a destination based on parameters stored in database 106 relating to each trip the vehicle 102 has taken. More specifically, the processor 105 is programmed with an algorithm that predicts destinations based on such stored parameters relating to trips that the vehicle 102 has made in the past.

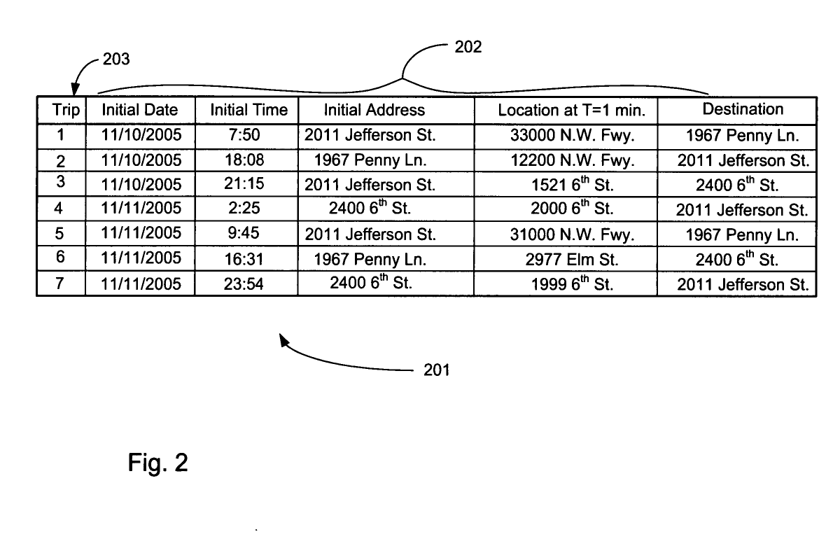

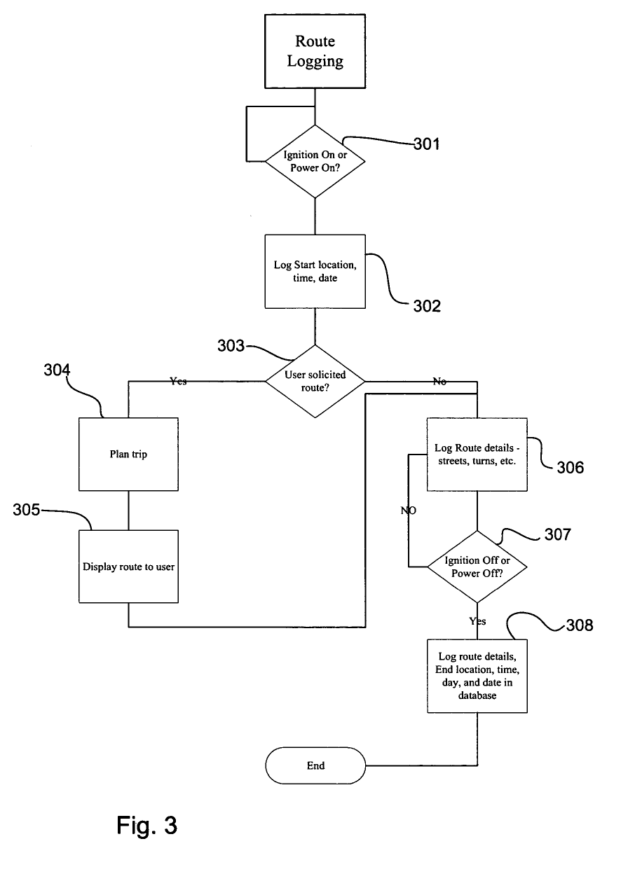

A trip might be considered as the duration from the time the navigation system 101 is activated (i.e., commensurate with starting vehicle 102) until the system 101 is deactivated (i.e., when the vehicle 102 is turned off). FIG. 2 illustrates a portion of a database 201 containing a collection of exemplary parameters 202 relating to a plurality of trips 203, and FIG. 3 illustrates a process of logging these parameters during an exemplary trip. Exemplary parameters 202 include INITIAL DATE, INITIAL TIME, INITIAL ADDRESS, LOCATION AT T=1 MIN., and DESTINATION. Other parameters may include heading, day of week and number of passengers in the car. The processor 104 is configured to use these parameters logged during past trips to predict a destination of a present trip.

FIG. 3 illustrates a logging routine for collecting the parameters illustrated in FIG. 2. According to one embodiment, the logging routine can be active any time the navigation system 101 is active. The logging routine can initiate when the navigation system 101 is powered up or when the ignition of the vehicle 102 is turned on 301. INITIAL TIME, INITIAL DATE, and INITIAL ADDRESS can be determined 302 when the navigation system 101 is activated. For example, when the vehicle 102 is started, the navigation system 101 creates a file and saves the initial date, time, and address (provided by the GPS receiver 105) in the file, which immediately or eventually is stored in the database 106. On activation, the navigation system 101 detects whether the user wants to plan, (or solicit) a route 303 through the navigation system 101 (by depressing the “go to” or “address” buttons on the user interface, not shown in FIG. 1) or if the user has no intention of using the navigation system 101 for a route to the destination. If user chooses to select or input a destination, or otherwise solicit the system 101 to plan a route, the navigation system 101 can plan 304 and display 305 a route to the user. As described above, the route can be planned according to one or more criteria, including shortest distance, current traffic conditions, avoiding tolls, etc. According to one embodiment, the route can be continually updated based on updated information concerning changing traffic conditions.

As the trip commences, either along the planned route or along an unsolicited route, the system 101 can continue to log 306 one or more additional parameters for the route. For example, the system 101 can log route details such as the streets traversed during the route, turns, directions, etc. Alternatively, the system 101 might simply log vehicle locations at various time intervals. These one or more additional parameters help the algorithm predict future destinations by discriminating between different destinations associated with trips beginning at the same initial address. For example, many trips have an INITIAL ADDRESS that is the user's home address. By checking the user's position one minute into a trip, some destinations will be more likely than others. The database 201 depicted in FIG. 2 simply shows the additional parameter of LOCATION AT T=1 MIN. for simplicity, but the database 201 can contain numerous additional parameters. The logging routine can continually check to see if the system 101 and/or vehicle 102 are powered down 307 and can continue to log route details as long as the system 101 is active.

When trip is complete, i.e., when the solicited destination is reached or when the system 101 and/or vehicle 102 are powered down, the logging routine logs the route details 308 such as DESTINATION, end time, and end day/date. The DESTINATION parameter may be simply the last address indicated by the GPS receiver 205 before the navigation system 101 is turned off.

The parameters listed in FIG. 2 are merely exemplary and one of skill in the art will recognize that any number of parameters might be useful to the predictive nature of the disclosed system. For example, if two or more users use the vehicle 102, the navigation system 101 might predict different destinations depending on which user is operating vehicle 102. Thus, the navigation system 101 might use parameters relating to the identity of the user, for example, seat position or a personalized ignition key etc., to help improve the reliability of the predicted destination.

A predictive strategy of the presently disclosed navigation system 101 is illustrated as follows: referring again to FIG. 2, trips 1 and 5 occurred on weekday mornings, originated from the same INITIAL ADDRESS (2011 Jefferson St.), and terminated at the same DESTINATION (1967 Penny Ln.). Based on these parameters, if the navigation system 101 is activated on a weekday morning at an INITIAL ADDRESS OF 2011 Jefferson St., the navigation system 101 is likely to predict that 1967 Penny Ln. is the most probable DESTINATION. The second most probable DESTINATION might be 2400 6^{th} St., another DESTINATION corresponding to an INITIAL ADDRESS OF 2011 Jefferson St. On start-up, the navigation system 101 prompts the user to select a DESTINATION from a list of addresses and arranges the list such that 1967 Penny Ln. is the first address on the list and 2400 6^{th} St. is the second address on the list. Once the user selects a destination, the navigation system 101 determines a route to the destination based on traffic information received via the traffic information receiver 108.

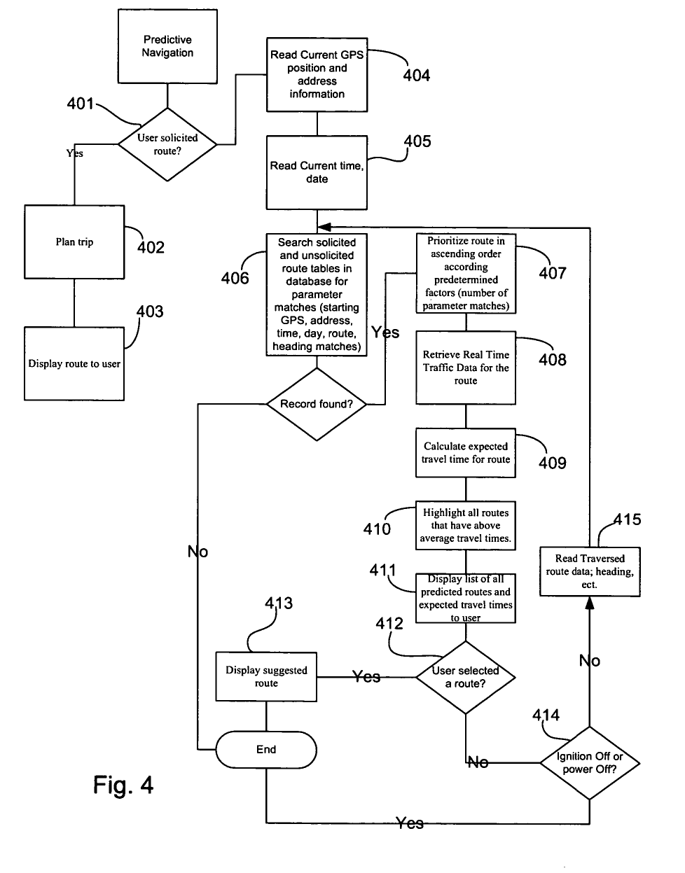

FIG. 4 is a flow chart describing an alternative embodiment wherein the navigation system 101 provides route information for a number of unsolicited destinations, without requiring the user to select a destination. When the navigation system 101 is initiated, the system 101 customarily queries the user to solicit a route 401. If the user does solicit the navigation system 101 to determine a route, the system 101 plans a trip 402 and displays the route to the user 403. If the user does not solicit the navigation system 101 to provide a route, the system 101 reads its present position 404, time/date 405, etc.; and searches the database 406 for routes corresponding to these parameters. If corresponding routes are found, the navigation system 101 prioritizes 407 the routes by comparing the present time and location of the vehicle 102to saved parameters associated with each of the routes, as described above. Rather than querying the user to select one of the routes according to the embodiment described above, the navigation system 101 retrieves real time traffic data for each of the predicted routes 408 and calculates expected travel times for each of routes 409. According to one embodiment, the navigation system 101 highlights or otherwise advises the user of routes that have above average travel times 410. The system 101 displays a list of all the predicted routes and expected travel times to the user 411.

At any time during the trip, the user can select or confirm one of the routes from the displayed list 412, causing the navigation system 101 to display the recommended route to the user 413. Absent a selection by the user, the navigation system 101 continues to check if ignition/power is on 414, and if so, continues to monitor and collect route data such as location, heading, etc. 415. Using the continually updated route data from the present trip, the navigation system 101 continues to update and reprioritize the displayed routes 406, 407 and update the calculated routes based on continually received real time traffic data.

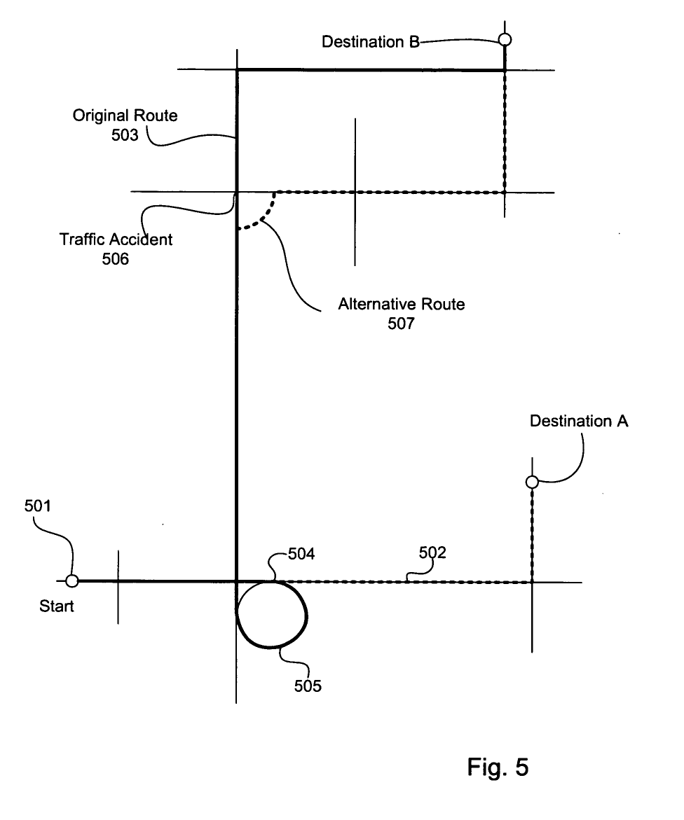

As the trip progresses, some of the predicted routes may cease to be relevant, for example as the user passes through a “decision point” such as an intersection or interchange. Other routes may be recalculated, for example because of a traffic accident or congestion that occurs after the trip has commenced. These aspects are illustrated graphically in FIG. 5.

Referring to FIG. 5, a user begins a trip at starting point 501 and does not solicit the navigation system 101 to provide a route to any particular destination. According to the steps described above, the navigation system 101 identifies two possible destinations, A and B, and predicts routes 502 and 503 to these destinations. The navigation system 101 continually monitors traffic conditions and updates and provides predicted travel times along both of routes 502 and 503 until one or both of these routes become unlikely routes for the present trip. For example, the vehicle 102 reaches a decision point at 504. When the vehicle 102 enters interchange 505, destination A ceases to be a likely destination and the route list is updated so that destination A is no longer displayed, or displayed as a very low possibility.

Still referring to FIG. 5, at some point during the trip, the navigation system 101 might receive real time traffic information indicating a delay along a predicted route. For example, the navigation system 101 might receive news of a traffic accident at intersection 506. Thus, original route 503 is updated to reflect a longer travel time than originally predicted. The navigation system 101 determines an alternative route 507 to destination B and continues to provide travel times for the alternative route 507 and the original route 503 to the user.

Although this disclosure discusses the relevance of addresses (e.g., originating addresses and destination addresses), it should be understood that “addresses” can also include information over and beyond a mere street address (e.g., 123 Elm Street), and can include merely positional information, such as GPS information, longitude and latitude coordinates, etc.

It should be understood that the inventive concepts disclosed herein are capable of many modifications. To the extent such modifications fall within the scope of the appended claims and their equivalents, they are intended to be covered by this patent.

What is claimed is:

1. A method for predicting a destination of a vehicle, comprising:
for a plurality of completed trips, saving one or more parameters relating to each completed trip in a database,
comparing the one or more saved parameters to one or more corresponding parameters relating to a present trip, and
predicting a most likely destination for the present trip based on the comparison.

2. The method of claim 1, further comprising presenting the predicted most likely destination for the present trip to provide route information to the user

3. The method of claim 2, wherein the route information is provided taking traffic conditions into account.

4. The method of claim 1, further comprising, informing a user of the vehicle of the predicted most likely destination, and asking the user to confirm that destination so that route information might be provided to the user.

5. The method of claim 1, wherein the one or more parameters are saved in a database.

6. The method of claim 1, further comprising presenting to a user the determined most likely destination and prompting the user to confirm the prediction.

7. The method of claim 6, wherein presenting to a user the determined most likely destination comprises presenting the user with a list of destinations that is prioritized according to the predicted most likely destination.

8. A method of determining a route from a present position to a destination of a present trip in a vehicle, comprising:
comparing one or more parameters relating to the present trip to corresponding one or more parameters relating to a plurality of past trips of the vehicle;
determining a most likely destination based on the comparison;
asking a user of the vehicle to select the most likely destination or to choose another destination; and
determining route information between the present position and the selected most likely destination or the chosen another destination.

9. The method of claim 8, wherein the corresponding one or more parameters relating to a plurality of past trips of the vehicle is stored in a database.

10. The method of claim 8, further comprising determining a plurality of likely destinations including the most likely destination.

11. The method of claim 8, wherein asking a user of the vehicle to select comprises presenting the user with a list of destinations that is prioritized according to the determined most likely destination.

12. The method of claim 8, further comprising predicting a travel time to the most likely destination and displaying the predicted travel time to the user.

13. The method of claim 12, further comprising continuously updating as the predicted travel time.

14. The method of claim 9, wherein determining route information comprises receiving information about current traffic conditions.

15. A system for predicting navigation routes for a present trip of a vehicle, comprising:
a database for storing parameters relating to a plurality of trips of the vehicle;
a processor programmed to:
(I) compare one or more parameters relating to the present trip to corresponding one or more parameters relating to a plurality of past trips of the vehicle and determine one or more likely destinations, based on the comparison, and
(II) determine routes to the one or more likely destination; and
display the routes to a user.

16. The system of claim 15, further comprising a traffic information receiver for receiving real time traffic information, wherein the processor is further programmed to use the received real time traffic information to predict travel times to the one or more likely destinations.

17. The system of claim 16, wherein the processor is further programmed to continually update the predicted travel times during the present trip.

18. The system of claim 15, wherein the processor is further programmed to update the one or more likely destinations during the present trip.

19. The system of claim 15, wherein the processor is further programmed to present the user with a list of the determined likely destinations and prompt the user to select a destination from the list.

20. The system of claim 19, wherein the processor is programmed to provide the user with suggested route when a destination is selected.
